(19) United States
(12) Patent Application Publication
(10) Pub. No.: US 2019/0362709 A1
(43) Pub. Date: Nov. 28, 2019

(54) Offline Voice Enrollment

(71) Applicant: Motorola Mobility LLC, Chicago, IL (US)

(72) Inventors: Amit Kumar Agrawal, Bangalore (IN); Joel A. Clark, Woodridge, IL (US); Rajib Acharya, Vernon Hills, IL (US); Pratik M. Kamdar, Naperville, IL (US)

(73) Assignee: Motorola Mobility LLC, Chicago, IL (US)

(21) Appl. No.: 15/990,059

(22) Filed: May 25, 2018

(51) Int. Cl. G10L 15/06; G10L 15/22; G10L 15/02

(52) U.S. Cl. CPC G10L 15/063; G10L 15/22; G10L 2015/025; G10L 2015/223; G10L 15/02

(57) ABSTRACT

A device receives voice inputs from a user and can perform various different tasks based on those inputs. The device is trained based on the user's voice by having the user speak a desired command. The device receives the voice input from the user and applies various different voice training parameters to generate a voice model for the user. The training parameters used by the device can change over time, so the voice input used to train the device based on the user's voice is stored by the device in a protected (e.g., encrypted) manner. When the training parameters change, the device receives the revised training parameters and applies these revised training parameters to the protected stored copy of the voice input to generate a revised voice model for the user.

### BACKGROUND

As technology has advanced, people have become increasingly reliant upon a variety of different computing devices, including wireless phones, tablets, laptops, and so forth. Users have come to rely on voice interaction with some computing devices, providing voice inputs to the computing devices to have various operations performed. While these computing devices offer a variety of different benefits, they are not without their problems. One such problem is that performance of these computing devices typically improves when users train the device to understand their voices. However, the parameters that computing devices use to determine what command was desired by a particular voice input can change over time, resulting in users needing to re-train the computing device. This re-training can be cumbersome and confusing on the part of the user, which can lead to user dissatisfaction and frustration with their computing devices.

### SUMMARY

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

In accordance with one or more aspects, a voice input is received from a user of a computing device, the voice input comprising a command for the computing device to perform one or more actions. Voice training parameters are applied to generate a voice model for the command for the user, and a protected copy of the voice input is stored. For each of a first set of multiple additional voice inputs, the voice model is used to analyze the additional voice input to determine whether the additional voice input is the command, and the command is performed in response to determining that the additional voice input is the command. Revised voice training parameters are subsequently obtained. The revised voice training parameters are applied to the protected copy of the voice input to generate a revised voice model for the command for the user. For each of a second set of multiple additional voice inputs received after the revised voice model is generated, the revised voice model is used to analyze the additional voice input to determine whether the additional voice input is the command, and the command is performed in response to determining that the additional voice input is the command.

In accordance with one or more aspects, a computing device includes a processor and a computer-readable storage medium having stored thereon multiple instructions that, responsive to execution by the processor, cause the processor to perform acts. The acts include obtaining revised voice training parameters for a command, applying the revised voice training parameters to a protected copy of a previously received voice input to generate a revised voice model for the command for a user of the computing device, and replacing a previously generated user-trained voice model with the revised voice model. The acts further include, for each of a set of multiple additional voice inputs received after the revised voice model is generated, using the revised voice model to analyze the additional voice input to determine whether the additional voice input is the command, and performing the command in response to determining that the additional voice input is the command.

In accordance with one or more aspects, a computing device includes a microphone and a voice control system implemented at least in part in hardware. The voice control system includes a training module and a command execution module. The training module, implemented at least in part in hardware, is configured to obtain revised voice training parameters for a command, apply the revised voice training parameters to a protected copy of a previously received voice input to generate a revised voice model for the command for a user of the computing device, and replace a previously generated user-trained voice model with the revised voice model. The command execution module, implemented at least in part in hardware, is configured to, for each of a set of multiple additional voice inputs received after the revised voice model is generated, use the revised voice model to analyze the additional voice input to determine whether the additional voice input is the command, and perform the command in response to determining that the additional voice input is the command.

### BRIEF DESCRIPTION OF THE DRAWINGS

Embodiments of offline voice enrollment are described with reference to the following drawings. The same numbers are used throughout the drawings to reference like features and components:

FIG. 1 illustrates an example computing device implementing the techniques discussed herein;

FIG. 2 illustrates an example system that generates user-trained voice models in accordance with one or more embodiments;

FIGS. 3A and 3B illustrate an example process for implementing the techniques discussed herein in accordance with one or more embodiments;

FIG. 4 illustrates various components of an example electronic device that can implement embodiments of the techniques discussed herein.

### DETAILED DESCRIPTION

Offline voice enrollment is discussed herein. A computing device receives voice inputs from a user and can perform various different tasks based on those inputs. The computing device is trained based on the user's voice, allowing the computing device to better identify particular voice inputs (e.g., particular commands) from the user. One command that can be input from the user is a launch phrase. In response to detecting the launch phrase (also referred to as a launch command), the computing device activates itself for receiving additional commands. The launch command can be received at various times, such as when the computing device is in a low-power or screen-off mode, when the screen is turned off and the computing device is locked, and so forth. The computing device is trained to recognize commands such as the launch phrase as spoken by the user, a process that is also referred to as voice enrollment or simply enrollment. Voice enrollment allows the computing device to more accurately identify the command when spoken by the user, and further allows the computing device to distinguish between different users so that the computing device performs the command only in response to an authorized user (the enrolled user) providing the command. For example, only an authorized user is able to activate the computing device to receive additional commands using the launch phrase.

Training the computing device based on the user's voice is performed by having the user speak a desired command. The computing device receives the voice input from the user and applies various different voice training parameters, such as phoneme definitions and tuning parameters, to the voice input to generate a voice model for the user. The computing device uses this voice model to analyze subsequently received voice inputs to the computing device in order to determine whether a particular command is input by the user.

The training parameters used by the computing device can and often do change over time, such as to improve the performance of the training. The voice input used to train the computing device based on the user's voice is stored by the computing device in a protected manner, such as being stored in an encrypted form. When the training parameters change, the computing device receives the revised training parameters and applies these revised training parameters to the protected stored copy to generate a revised voice model for the user. The computing device uses this revised voice model to analyze subsequently received voice inputs to the computing device in order to determine whether a particular command is input by the user. The computing device thus effectively re-enrolls the user based on the revised training parameters without needing the user to re-speak the desired command. The re-enrollment is also referred to as offline voice enrollment because the user is re-enrolled based on the revised training parameters and the protected stored copy of the user's voice input—the user need not re-speak the voice input for the re-enrollment.

The techniques discussed herein improve the performance of the computing device in recognizing voice inputs by incorporating the revised training parameters without requiring any additional input or action by the user. The user need not re-speak any commands in order to generate the revised voice model. In one or more embodiments, the computing device can generate the revised voice model automatically without the user having any knowledge that the revised voice model has been generated.

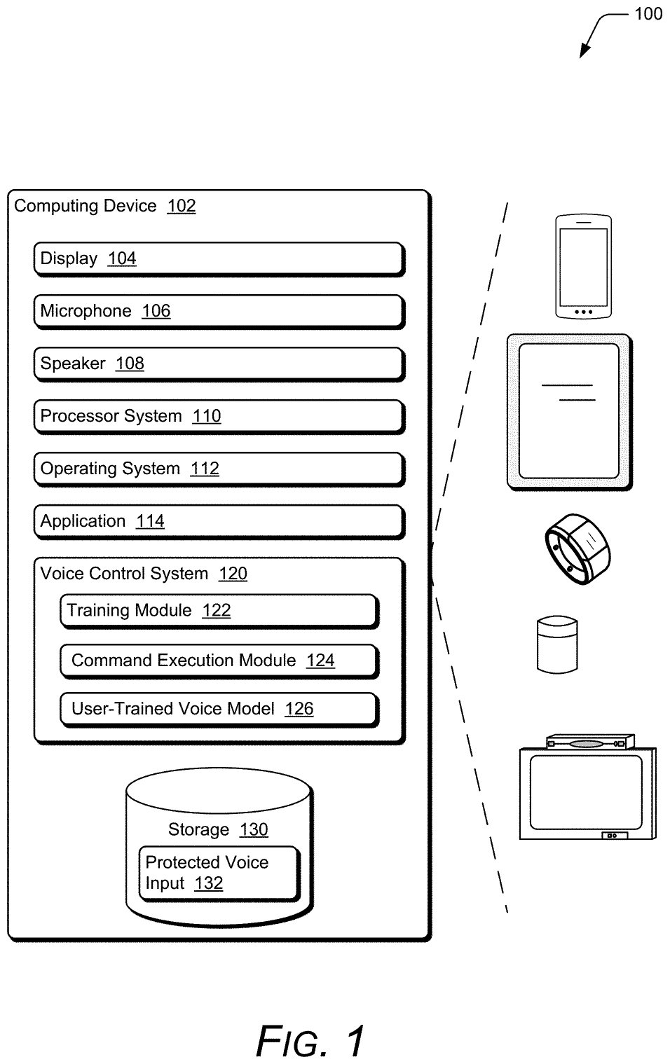

FIG. 1 illustrates an example computing device 102 implementing the techniques discussed herein. The computing device 102 can be, or include, many different types of computing or electronic devices. For example, the computing device 102 can be a smartphone or other wireless phone, a notebook computer (e.g., netbook or ultrabook), a laptop computer, a camera (e.g., compact or single-lens reflex), a wearable device (e.g., a smartwatch, an augmented reality headset or device, a virtual reality headset or device), a tablet or phablet computer, a personal media player, a personal navigating device (e.g., global positioning system), an entertainment device (e.g., a gaming console, a portable gaming device, a streaming media player, a digital video recorder, a music or other audio playback device), a video camera, an Internet of Things (IoT) device, an automotive computer, and so forth.

The computing device 102 includes a display 104, a microphone 106, and a speaker 108. The display 104 can be configured as any suitable type of display, such as an organic light-emitting diode (OLED) display, active matrix OLED display, liquid crystal display (LCD), in-plane shifting LCD, projector, and so forth. The microphone 106 can be configured as any suitable type of microphone incorporating a transducer that converts sound into an electrical signal, such as a dynamic microphone, a condenser microphone, a piezoelectric microphone, and so forth. The speaker 108 can be configured as any suitable type of speaker incorporating a transducer that converts an electrical signal into sound, such as a dynamic loudspeaker using a diaphragm, a piezoelectric speaker, non-diaphragm based speakers, and so forth.

Although illustrated as part of the computing device 102, it should be noted that one or more of the display 104, the microphone 106, and the speaker 108 can be implemented separately from the computing device 102. In such situations, the computing device 102 can communicate with the display 104, the microphone 106, and/or the speaker 108 via any of a variety of wired (e.g., Universal Serial Bus (USB), IEEE 1394, High-Definition Multimedia Interface (HDMI)) or wireless (e.g., Wi-Fi, Bluetooth, infrared (IR)) connections. For example, the display 104 may be separate from the computing device 102 and the computing device 102 (e.g., a streaming media player) communicates with the display 104 via an HDMI cable. By way of another example, the microphone 106 may be separate from the computing device 102 (e.g., the computing device 102 may be a television and the microphone 106 may be implemented in a remote control device) and voice inputs received by the microphone 106 are communicated to the computing device 102 via an IR or radio frequency wireless connection.

The computing device 102 also includes a processor system 110 that includes one or more processors, each of which can include one or more cores. The processor system 110 is coupled with, and may implement functionalities of, any other components or modules of the computing device 102 that are described herein. In one or more embodiments, the processor system 110 includes a single processor having a single core. Alternatively, the processor system 110 includes a single processor having multiple cores and/or multiple processors (each having one or more cores).

The computing device 102 also includes an operating system 112. The operating system 112 manages hardware, software, and firmware resources in the computing device 102. The operating system 112 manages one or more applications 114 running on the computing device 102, and operates as an interface between applications 114 and hardware components of the computing device 102.

The computing device 102 also includes a voice control system 120. Voice inputs to the computing device 102 are received by the microphone 106 and provided to the voice control system 120. Generally, the voice control system 120 analyzes the voice inputs, determines whether the voice inputs are a command to be acted upon by the computing device 102, and in response to a voice input being a command to be acted upon by the computing device 102 initiates the command on the computing device 102.

The voice control system 120 can be implemented in a variety of different manners. For example, the voice control system 120 can be implemented as multiple instructions stored on computer-readable storage media and that can be executed by the processor system 110. Additionally or alternatively, the voice control system 120 can be implemented at least in part in hardware (e.g., as an application-specific integrated circuit (ASIC), a field-programmable gate array (FPGA), and so forth).

The voice control system 120 includes a training module 122, a command execution module 124, and a user-trained voice model 126. The training module 122 trains the computing device 102 to associate a particular voice input with a particular command for a user. The training module 122 receives the voice input from the user (e.g., via the microphone 106) and applies various different voice training parameters, such as phoneme definitions and tuning parameters, to generate a voice model for the user. This voice model is the user-trained voice model 126. The voice control system 120 stores or otherwise maintains the user-trained voice model 126.

The training module 122 can perform the training in a variety of different manners, and the training can be initiated by a user of the computing device 102 (e.g., by selecting a training option or button of the computing device 102) and/or by the computing device 102 (e.g., the training module 120 initiating training during setup or initialization of the computing device 102). The training can be performed in different manners, such as by the training module 120 prompting (e.g., audibly via speaker 108 or visually via display 104) when to speak, by the training module 120 displaying one or more words to be spoken, by user inputs that are key, button, or other selections indicating beginning and ending of a command, and so forth.

Different people speak in different manners, and the same person speaking into different hardware can result in different voice inputs, so the training module 122 generates the user-trained voice model 126. The training module 122 generates the user-trained voice model 126 by obtaining the voice input during training and applying a set of voice training parameters to the obtained voice input. These training parameters can include, for example, phonemes and tuning parameters as discussed in more detail below. The training discussed herein (e.g., training of the computing device 102, the voice control system 120, and/or the training module 122) refers to generating the user-trained voice model 126 by applying a set of voice training parameters to a voice input. The voice input used by the training module 122 to generate the user-trained voice model 126 can be a single user utterance of a particular phrase or command, or alternatively multiple utterances of the particular phrase or command. For example, if the user-trained voice model 126 is being trained for a launch phrase of “Hello computer”, then the voice input used to generate the user-trained voice model 126 can be a single utterance of the phrase “Hello computer”, or multiple utterances of the phrase “Hello computer”.

The user-trained voice model 126 effectively customizes the voice control system 120 to the user for a command. Because different people speak in different manners, the use of user-trained voice model 126 allows the voice control system 120 to more accurately identify a voice input from the user that is the command. This improved accuracy reduces the number of false acceptances (where the voice control system 120 determines that a particular command, such as the launch phrase, was spoken by the user when in fact the particular command was not spoken by the user) as well as the number of false rejections (where the voice control system 120 determines that a particular command, such as the launch phrase, was not spoken by the user when in fact the particular command was spoken by the user) for the voice control system 120. Furthermore, this training can be used to distinguish between different users, improving security of the computing device 102. By having the user-trained voice model 126 trained for a particular user, a voice input from that particular user can be determined by the voice control system 120 as coming from that particular user rather than some other user. Additionally, if a second user were to provide a voice input that is the command, the voice control system 120 can determine that the voice input is not from the second user.

For example, assume user A owns computing device 102, keeping computing device 102 in his or her home. User A speaks into the microphone 106 to provide a voice input to the computing device 102 that is a launch phrase for the computing device 102, and the training module 122 uses that voice input to train the user-trained voice model 126 for the launch phrase for user A. Further assume that user B is an acquaintance of user A that is visiting user A's home. If user B speaks the launch phrase into the microphone 106, the voice control system 120 will not execute a launch command (e.g., will not activate the computing device 102 to receive additional voice inputs) because the user-trained voice model 126 will not identify the voice input as the launch phrase spoken by user A due to the differences in voices and the manners in which users A and B speak.

The user-trained voice model 126 can be implemented using any of a variety of public and/or proprietary speech recognition models and techniques. For example, the user-trained voice model 126 can be implemented using Hidden Markov Models (HMMs), Long Short-Term Memory (LSTM) Recurrent Neural Networks (RNNs), Time Delay Neural Networks (TDNNs), Deep Feedforward Neural Networks (DNNs), and so forth.

The voice training parameters that the training module 122 uses can take various different forms based at least in part on the manner in which the user-trained voice model 126 is implemented. By way of example, the voice training parameters can include phonemes and tuning parameters. The voice training parameters can include different tuning parameters for each of multiple different phonemes, such as the duration of the phoneme, a frequency range for each of multiple different phonemes, and so forth. A command can be made up of multiple phonemes and the voice training parameters can include different tuning parameters for the sequence in which different phonemes are combined, such as which phonemes occur in the sequence and the order in which those phonemes occur in the sequence, the duration of the sequence, the duration between phonemes in the sequence, and so forth. The voice training parameters can also include additional tuning parameters regarding the command, such as the number of enrollment inputs to receive (the number of times to have the user provide the voice input).

Training refers to generating a model that customizes these tuning parameters for a particular user. For example, a particular parameter may indicate the duration of a particular phoneme in a command. The voice training parameters may indicate that the duration of that particular phoneme in the command is between 30 and 60 milliseconds, and when the user speaks the command the duration may be 40 milliseconds. The training module 122 can generate the user-trained voice model to reflect that the duration of that particular phoneme for the current user is 40 milliseconds (or within a threshold amount of 40 milliseconds, such as between 38 and 40 milliseconds, or at least a threshold probability (e.g., 80%) that the phoneme was uttered for 40 milliseconds).

The voice training parameters can change over time as desired by the developer or distributor of the voice control system 120. These changes can be to add parameters, remove parameters, change values of parameters, combinations thereof, and so forth. The changes to the parameters are made available to the voice control system 120 as revised voice training parameters.

The training module 122 can train a single user-trained voice model 126 or alternatively multiple user-trained voice models 126. For example, the training module 122 can generate a different user-trained voice model 126 for each command that the voice control system 120 desires to recognize by voice input. By way of another example, the training module 122 can train a single user-trained voice model 126 for one command (e.g., a launch command or launch phrase) and use another voice model (e.g., a speaker independent model) for other commands (e.g., search commands, media playback commands).

The user-trained voice model 126 is illustrated as part of the voice control system 120. In one or more embodiments the user-trained voice model 126 is maintained in computer-readable storage media of the computing device 102 while the voice control system 120 is running, such as in random access memory (RAM), Flash memory, and so forth. The user-trained voice model 126 can also optionally be stored in a storage device 130. The storage device 130 can be implemented using any of a variety of storage technologies, such as magnetic disk, optical disc, Flash or other solid state memory, and so forth.

The user's voice input is received by the microphone 106 and converted to electrical signals that can be processed and analyzed by the voice control system 120. For example, the user's voice input can be a sound wave that is converted to a sequence of samples referred to as a discrete-time signal. This conversion can be performed using any of a variety of public and/or proprietary techniques.

The voice input that is received and used by the training module 122 to train the user-trained voice model 126 is also saved by the voice control system 120 (e.g., the training module 122) as protected voice input 132. This allows the voice input to be saved and used to train a new user-trained voice model 126 (or retrain a current user-trained voice model 126) using additional training parameters as discussed in more detail below. In one or more embodiments, the protected voice input 132 is the converted sequence of samples (e.g., a discrete-time signal) from the microphone 106.

The voice input is stored as protected voice input 132 so that the voice input can be re-used for the user for which enrollment was performed but not other users. This protection can be implemented in a variety of different manners. For example, the voice input can be encrypted using a key associated with the user. This key can be made available to an encryption/decryption service of the computing device 102 (e.g., a program of the operating system 112, a hardware component of the computing device 102) when the user is logged into the computing device 102 (e.g., when the user has provided a password, personal identification number, fingerprint, etc. to verify his or her identity). By way of another example, this key can be made available to an encryption/decryption service of the computing device 102 in response to input of a password, personal identification number, or other identifier (e.g., via one or more buttons or keys of the computing device 102) of the user. By way of another example, the voice input may be protected (regardless of whether encrypted) by being stored in a storage device or portion of a storage device that is only accessible when the user is logged into the computing device 102.

It should also be noted that although the protected voice input 132 is illustrated as being stored in storage 130 that is part of the computing device 102, the protected voice input 132 can additionally or alternatively be stored in other locations. For example, the protected voice input 132 can be stored in a different device of the user's, can be stored in the cloud or another service, and so forth.

In one or more embodiments, the protected voice input 132 is whatever phrase or command was used by the training module 122 to generate the user-trained voice model 126. For example, if a single utterance of a launch phrase “Hello computer” was used to train the user-trained voice model 126, then that single utterance of the launch phrase “Hello computer” is saved as the protected voice input 132. By way of another example, if multiple utterances of the launch phrase “Hello computer” were used to train the user-trained voice model 126, then those multiple utterances of the launch phrase “Hello computer” are saved as the protected voice input 132. The multiple utterances can be saved individually (e.g., as individual records or files) or alternatively can be combined (e.g., the converted sequence of samples (e.g., a discrete-time signal) for each utterance can be concatenated to generate a combined converted sequence of samples).

The command execution module 124 uses the user-trained voice model 126 to analyze subsequently received voice inputs to the computing device 102 in order to determine whether a particular command is input by the user. The command execution module 124 analyzes voice inputs received by the microphone 106 and uses the user-trained voice model 126 to determine whether a user input corresponds to a particular command. The command execution module 124 initiates or executes the command by performing none or more actions on the computing device 102 in response to a voice input corresponding to the command (as indicated by the user-trained voice model 126) is received. The initiation or execution of a command can take various forms, such as executing a program of the operating system 112, executing an application 114 to run on the computing device 102, notifying a program of the operating system 112 or application 114 of particular operations and/or parameters (e.g., enter a search phrase to an Internet search program, control playback of media content).

In one or more embodiments, the user-trained voice model 126 corresponds to a launch command, and in response to the user-trained voice model 126 determining that a voice input (a launch phrase) is received that corresponds to the launch command the action that the command execution module 124 takes is activating the computing device 102 to receive additional commands. This activation can take various forms, such as running a program of the operating system 112 or an application 114, notifying the command execution module 124 to begin analyzing voice inputs for correspondence to different voice models (e.g., different user-trained voice models 126), and so forth. In such embodiments, the voice control system 120 does not respond to commands (e.g., the command execution module 124 does not execute commands) until after the launch phrase is received by the computing device 102. Once the launch phrase has been received, the voice control system 120 can continue to receive additional voice inputs and execute additional commands corresponding to the received additional voice inputs for some duration of time (e.g., a threshold amount of time (e.g., 10 seconds) after the launch phrase is received, a threshold amount of time (e.g., 12 seconds) after the most recent execution of a command the command execution module 124).

The training parameters used by the training module 122 can and often do change over time, such as to improve the performance of the training. When the training parameters change, the computing device 102 receives the revised training parameters and applies these revised training parameters to generate a revised user-trained voice model for the user. The computing device 102 uses this revised user-trained voice model to analyze subsequently received voice inputs to the computing device 102 in order to determine whether a particular command is input by the user. The computing device 102 thus effectively re-enrolls the user in an offline manner, which is based on the revised training parameters without needing the user to re-speak the desired command.

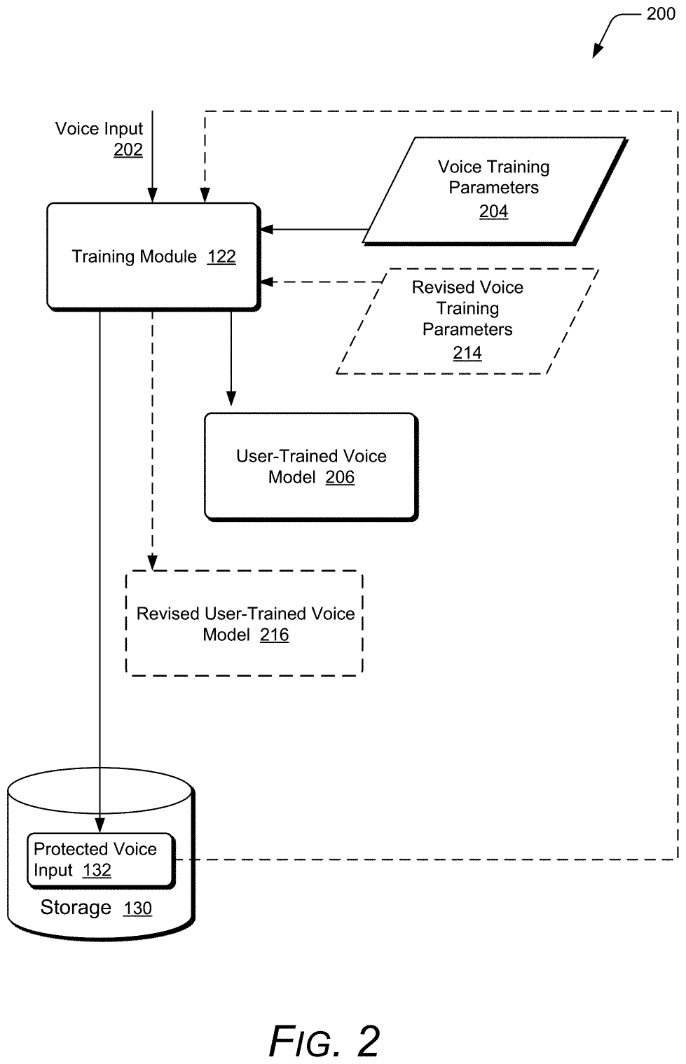

FIG. 2 illustrates an example system 200 that generates user-trained voice models in accordance with one or more embodiments. FIG. 2 is discussed with reference to elements of FIG. 1. The system 200 includes a training module 122 and storage 130, and can be part of the voice control system 120. The training module 122 receives a voice input 202 that is used to train a user-trained voice model, and saves the voice input 202 as protected voice input 132. The training module 122 also obtains voice training parameters 204. The training module 122 can obtain the voice training parameters 204 in various manners from various sources, such as by accessing a web site or receiving an email or other update communication from a developer or distributor of the computing device 102, by accessing a web site or receiving an email or other update communication from a developer or distributor of the operating system 112, by accessing other devices or systems, by having the voice training parameters 204 available in the computing device 102 as a part of application or operating system code, and so forth.

The training module 122 uses the voice training parameters 204 and the voice input 202 to generate the user-trained voice model 206. The user-trained voice model 206 can be, for example, the user-trained voice model 126 of FIG. 1. Once trained, the user-trained voice model 206 is used to analyze voice inputs and determine whether a voice input associated with a command corresponding to the user-trained voice model 206 is received by the computing device 102 as discussed above.

At some later time (e.g., days, weeks, or months later), revised voice training parameters 214 are obtained. The revised voice training parameters 214 can be obtained in various manners from various sources, analogous to the voice training parameters 204. The revised voice training parameters 214 can be obtained from the same or a different source as the voice training parameters 204.

The training module 122 uses the revised voice training parameters 214 and the protected voice input 132 to generate the revised user-trained voice model 216. Using the protected voice input 132 optionally includes temporarily undoing the protection on the voice input 132. For example, the protected voice input 132 can be decrypted temporarily (e.g., in random access memory) and used to generate the revised user-trained voice model 216, although the protected voice input 132 remains in protected form in storage 130. The revised user-trained voice model 216 can replace the previous user-trained voice model 206, for example becoming the new user-trained voice model 126 of FIG. 1. Once trained, the revised user-trained voice model 216 is used to analyze voice inputs and determine whether a voice input associated with a command corresponding to the user-trained voice model 216 is received by the computing device 102 as discussed above.

The training module 122 can generate the revised user-trained voice model 216 by applying the voice input to the revised voice training parameters in the same manner as the user-trained voice model 206 was generated, except that the revised voice training parameters 214 are used rather than the voice training parameters 204 and that the protected voice input 132 is used rather than the voice input 202. Additionally or alternatively, the training module 122 can generate the revised user-trained voice model 216 by modifying or re-training the user-trained voice model 206 based on the revised voice training parameters 214 and the protected voice input 132. The manner in which the user-trained voice model 206 can be modified or re-trained varies based on the manner in which the user-trained voice model 206 is implemented, and this modifying or re-training can be performed using any of a variety of public and/or proprietary techniques.

Thus, as can be seen from system 200, the same voice input 202 is used to generate the user-trained voice model 206 and subsequently the revised user-trained voice model 216. The revised user-trained voice model 216 is generated based on the revised voice training parameters 214 and the protected voice input 132, so the user need not re-input the voice input 202 to train the revised user-trained voice model 216. Any number of sets of revised voice training parameters can be obtained over time, and each set of revised voice training parameters can be used to generate a new revised user-trained voice model. For example, revised voice training parameters can be obtained by the training module 122 at regular intervals (e.g., monthly) or at irregular intervals (e.g., each time there is an update to the operating system 112).

The techniques discussed herein thus allow for staged enrollment for a voice control system and staged training of the user-trained voice model. The first stage is performed based on one set of voice training parameters and each subsequent stage is performed based on another (revised) set of voice training parameters. Any number of revised voice training parameters can be received and any number of revised user-trained voice models can be generated. By way of example, the first stage can occur when the user purchases a device and enrolls with the computing device 102. Multiple updates to the voice training parameters can be created by the device manufacturer and made available to the computing device 102, such as via an application store update, a check for updates made by the voice control system 120 at regular or irregular intervals. The training module 122 can generate a new revised user-trained voice model in response to receiving each of the multiple updates to the voice training parameters.

The training module 122 can automatically generate the revised user-trained voice model 216 in response to obtaining the revised voice training parameters 214 and without input from the user. In some situations, the user need not have knowledge of the revised voice training parameters or the generation of the revised user-trained voice model 216. Additionally or alternatively, the training module 122 can generate the revised user-trained voice model 216 based on the revised voice training parameters 214 in response to a request or authorization from the user of the computing device 102, or from another user or system (e.g., a developer or distributor of the computing device 102 or the operating system 112).

Generating the revised user-trained voice model 216 without needing the user to re-input the voice input 202 allows the performance of the user-trained voice model 216 to be improved (due to the revised voice training parameters 214) without needing the user to re-input the voice input 202. This improves usability of the computing device 102 because the user need not be concerned with expending time re-entering the voice input 202, and need not be concerned with why the user is being prompted to re-enter the voice input 202.

Furthermore, generating the revised user-trained voice model 216 without needing the user to re-input the voice input 202 allows the performance of the user-trained voice model 216 to be improved (due to the revised voice training parameters 214) regardless of the current setting of the computing device 102. Training the user-trained voice model 126 is typically performed in a quiet environment where additional noise from other users or other ambient noise is not present or is low. The training module 122, however, can use the protected voice input 132 to generate the revised user-trained voice model 216 in a noisy environment because the voice input being used is the previously entered and stored protected voice input 132—the noise from other users or other ambient noise present around the computing device 102 when the revised user-trained voice model 216 is being trained is irrelevant.

Once the revised user-trained voice model 216 is generated, the training module 122 can optionally display or otherwise present a notification at the computing device 102 that the voice control system 120 has been updated and improved, thereby notifying the user of the computing device 102 of the improvement. If an amount of improvement is available or can be readily determined, an indication of that amount of improvement can also be displayed or otherwise presented by the computing device 102. For example, if a voice recognition efficiency is associated with each of the voice training parameters 204 and the revised voice training parameters 214, then the difference between these voice recognition efficiencies can be used to determine the amount of improvement (e.g., the difference between these two voice recognition efficiencies divided by the voice recognition efficiency of the voice training parameters 204).

It should be noted that one or more of the various components, modules, systems, and so forth illustrated as being part of the computing device 102 or system 200 can be implemented at least in part on one or more remote devices, such as one or more servers. The remote device(s) can be accessed via any of a variety of wired and/or wireless connections. The remote device(s) can further be accessed via any of a variety of different data networks, such as the Internet, a local area network (LAN), a phone network, and so forth. For example, various functionality performed by one or more of the various components, modules, systems, and so forth illustrated as being part of the computing device 102 or system 200 can be offloaded onto a remote device (e.g., for performance of the functionality “in the cloud”).

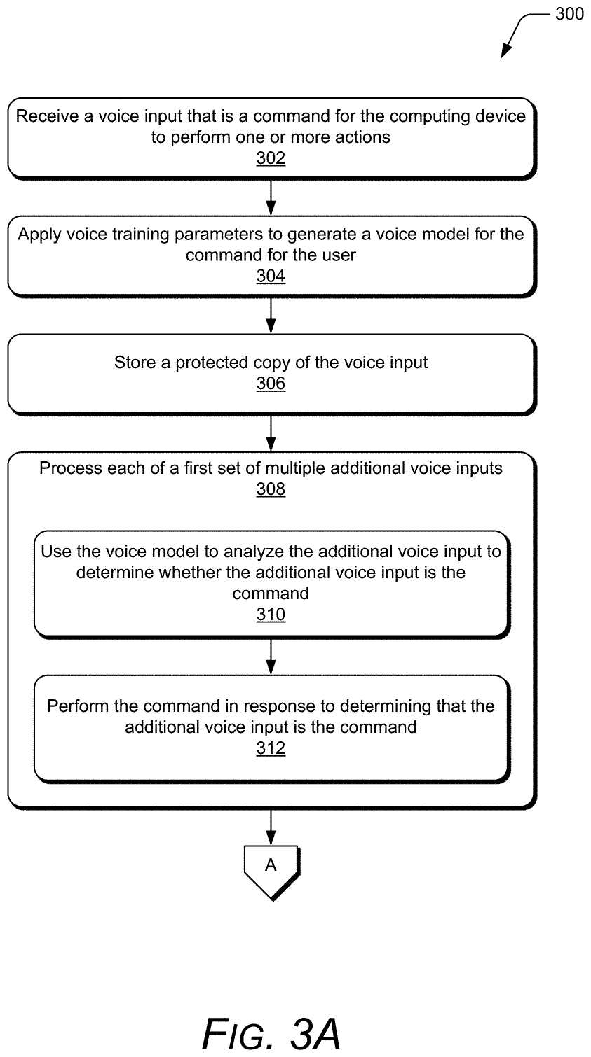

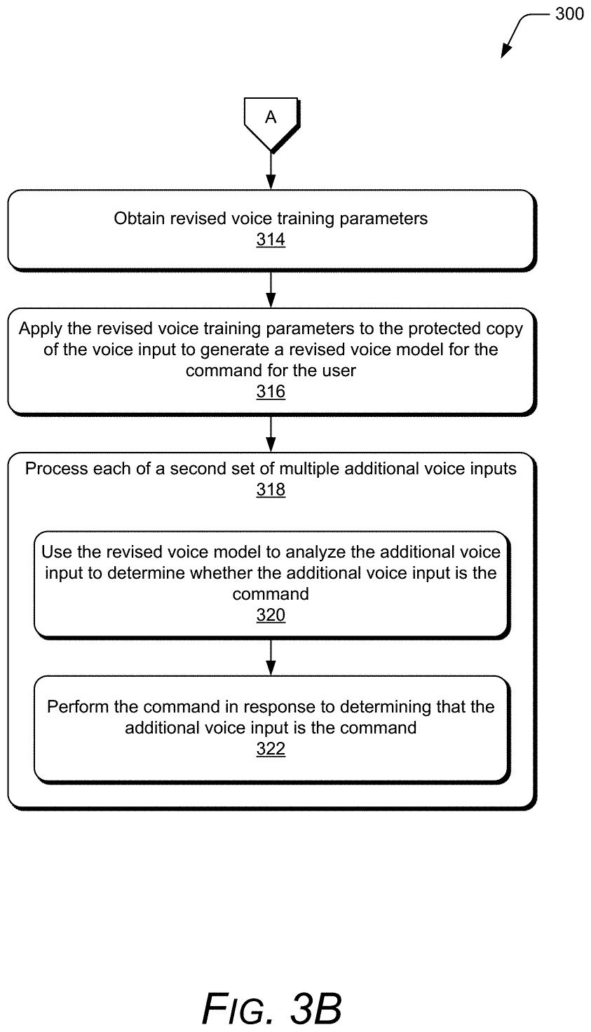

FIGS. 3A and 3B illustrate an example process 300 for implementing the techniques discussed herein in accordance with one or more embodiments. Process 300 is carried out by a voice control system, such as the voice control system 120 of FIG. 1, and can be implemented in software, firmware, hardware, or combinations thereof. Process 300 is shown as a set of acts and is not limited to the order shown for performing the operations of the various acts.

In process 300, a voice input that is a command for the computing device to perform one or more actions is received (act 302). This voice input is received as part of a training or enrollment process on the part of the user.

Voice training parameters are applied to generate a voice model for the command for the user (act 304). This voice model is a user-trained voice model, and the voice training parameters are applied by using the voice training parameters and the voice input received in act 302 to generate the voice model as discussed above.

A protected copy of the voice input is stored (act 306). The copy of the voice input can be protected in various manners as discussed above, such as being encrypted.

Each of a first set of multiple additional voice inputs are processed (act 308). Each additional voice input in the first set of multiple additional voice inputs is processed (and typically received) after the user-trained voice model is generated in act 304.

Processing a voice input of the first set of multiple additional voice inputs includes using the voice model to analyze the additional voice input to determine whether the additional voice input is the command (act 310). The command is performed in response to determining that the additional voice input is the command (act 312). Performing the command comprises executing or initiating the command as discussed above.

Revised voice training parameters are subsequently obtained (act 314). These revised voice training parameters can be received at any time subsequent to obtaining the voice training parameters used to generate the voice model in act 304 and/or after generating the voice model 304. For example, the revised voice training parameters can be received weeks or months after obtaining the voice training parameters used to generate the voice model in act 304 and/or after generating the voice model in act 304.

The revised voice training parameters are applied to the protected copy of the voice input to generate a revised voice model for the command for the user (act 316). This revised voice model is a revised user-trained voice model, and the revised voice training parameters are applied by using the revised voice training parameters and the protected copy of the voice input (which was received in act 302 and stored in act 306) to generate the revised voice model as discussed above. The protected copy of the voice input can be at least temporarily unprotected for use in generating the revised voice model. For example, the voice input can be protected by being encrypted in act 306, and the voice input can be decrypted for use in generating the revised voice model.

Each of a second set of multiple additional voice inputs are processed (act 318). Each additional voice input in the second set of multiple additional voice inputs is processed (and typically received) after the revised user-trained voice model is generated in act 316.

Processing a voice input of the second set of multiple additional voice inputs includes using the revised voice model to analyze the additional voice input to determine whether the additional voice input is the command (act 320). The command is performed in response to determining that the additional voice input is the command (act 322). Performing the command comprises executing or initiating the command as discussed above.

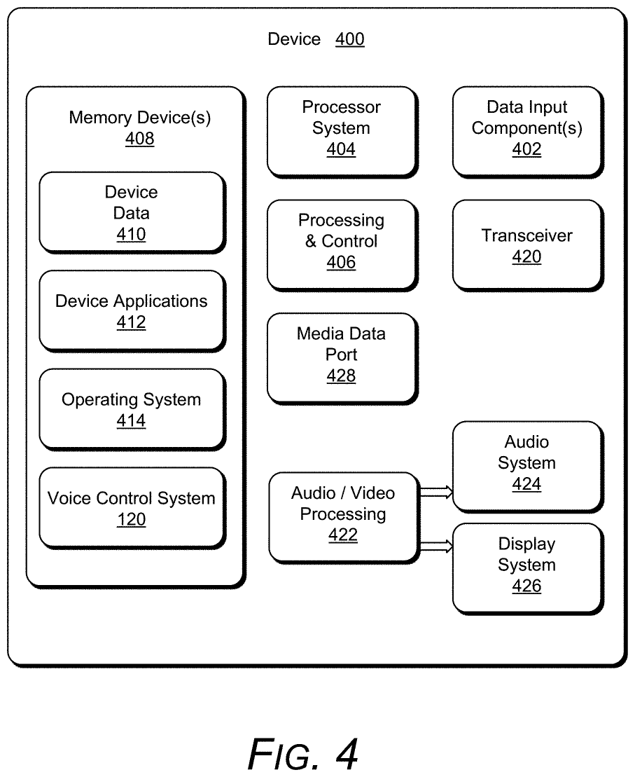

FIG. 4 illustrates various components of an example electronic device 400 that can be implemented as a computing device as described with reference to any of the previous FIGS. 1, 2, 3A, and 3B. The device 400 may be implemented as any one or combination of a fixed or mobile device in any form of a consumer, computer, portable, user, communication, phone, navigation, gaming, messaging, Web browsing, paging, media playback, or other type of electronic device.

The electronic device 400 can include one or more data input components 402 via which any type of data, media content, or inputs can be received such as user-selectable inputs, messages, music, television content, recorded video content, and any other type of audio, video, or image data received from any content or data source. The data input components 402 may include various data input ports such as universal serial bus ports, coaxial cable ports, and other serial or parallel connectors (including internal connectors) for flash memory, DVDs, compact discs, and the like. These data input ports may be used to couple the electronic device to components, peripherals, or accessories such as keyboards, microphones, or cameras. The data input components 402 may also include various other input components such as microphones, touch sensors, keyboards, and so forth.

The electronic device 400 of this example includes a processor system 404 (e.g., any of microprocessors, controllers, and the like) or a processor and memory system (e.g., implemented in a system on a chip), which processes computer executable instructions to control operation of the device 400. A processor system 404 may be implemented at least partially in hardware that can include components of an integrated circuit or on-chip system, an application specific integrated circuit, a field programmable gate array, a complex programmable logic device, and other implementations in silicon or other hardware. Alternatively or in addition, the electronic device 400 can be implemented with any one or combination of software, hardware, firmware, or fixed logic circuitry implemented in connection with processing and control circuits that are generally identified at 406. Although not shown, the electronic device 400 can include a system bus or data transfer system that couples the various components within the device 400. A system bus can include any one or combination of different bus structures such as a memory bus or memory controller, a peripheral bus, a universal serial bus, or a processor or local bus that utilizes any of a variety of bus architectures.

The electronic device 400 also includes one or more memory devices 408 that enable data storage such as random access memory, nonvolatile memory (e.g., read only memory, flash memory, erasable programmable read only memory, electrically erasable programmable read only memory, etc.), and a disk storage device. A memory device 408 provides data storage mechanisms to store the device data 410, other types of information or data (e.g., data backed up from other devices), and various device applications 412 (e.g., software applications). For example, an operating system 414 can be maintained as software instructions with a memory device and executed by the processor system 404.

In one or more embodiments the electronic device 400 includes a voice control system 120, described above. Although represented as a software implementation, the voice control system 120 may be implemented as any form of a control application, software application, signal processing and control module, firmware that is installed on the device 400, a hardware implementation of the modules, and so on.

Moreover, in one or more embodiments the techniques discussed herein can be implemented as a computer-readable storage medium having computer readable code stored thereon for programming a computing device (for example, a processor of a computing device) to perform a method as discussed herein. Computer-readable storage media refers to media and/or devices that enable persistent and/or non-transitory storage of information in contrast to mere signal transmission, carrier waves, or signals per se. Computer-readable storage media refers to non-signal bearing media. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. The computer-readable storage medium can be, for example, memory devices 408.

The electronic device 400 also includes a transceiver 420 that supports wireless and/or wired communication with other devices or services allowing data and control information to be sent as well as received by the device 400. The wireless and/or wired communication can be supported using any of a variety of different public or proprietary communication networks or protocols such as cellular networks (e.g., third generation networks, fourth generation networks such as LTE networks), wireless local area networks such as Wi-Fi networks, and so forth.

The electronic device 400 can also include an audio or video processing system 422 that processes audio data or passes through the audio and video data to an audio system 424 or to a display system 426. The audio system or the display system may include any devices that process, display, or otherwise render audio, video, display, or image data. Display data and audio signals can be communicated to an audio component or to a display component via a radio frequency link, S-video link, high definition multimedia interface (HDMI), composite video link, component video link, digital video interface, analog audio connection, or other similar communication link, such as media data port 428. In implementations the audio system or the display system are external components to the electronic device. Alternatively or in addition, the display system can be an integrated component of the example electronic device, such as part of an integrated touch interface.

Although embodiments of techniques for implementing offline voice enrollment have been described in language specific to features or methods, the subject of the appended claims is not necessarily limited to the specific features or methods described. Rather, the specific features and methods are disclosed as example implementations of techniques for implementing offline voice enrollment.

What is claimed is:

1. A method implemented in a computing device, the method comprising:
receiving a voice input from a user of the computing device, the voice input comprising a command for the computing device to perform one or more actions;
applying voice training parameters to generate a voice model for the command for the user;
storing a protected copy of the voice input;
for each of a first set of multiple additional voice inputs:
using the voice model to analyze the additional voice input to determine whether the additional voice input is the command, and
performing the command in response to determining that the additional voice input is the command;
subsequently obtaining revised voice training parameters;
applying the revised voice training parameters to the protected copy of the voice input to generate a revised voice model for the command for the user;
for each of a second set of multiple additional voice inputs received after the revised voice model is generated:
using the revised voice model to analyze the additional voice input to determine whether the additional voice input is the command; and
performing the command in response to determining that the additional voice input is the command.

2. The method as recited in claim 1, the training parameters comprising phonemes and tuning parameters.

3. The method as recited in claim 1, the command comprising a launch phrase that activates the computing device to receive additional commands

4. The method as recited in claim 1, the protected copy comprising an encrypted copy of the voice input.

5. The method as recited in claim 1, the storing the protected copy comprising storing the protected copy in a storage device of computing device.

6. The method as recited in claim 1, further comprising replacing the voice model with the revised voice model.

7. The method as recited in claim 6, further comprising:
repeating the obtaining revised voice training parameters and applying the revised voice training parameters to generate a revised voice model for each of multiple additional sets of revised voice training parameters.

8. The method as recited in claim 1, the applying the revised voice training parameters to the protected copy of the voice input to generate the revised voice model comprising applying the revised voice training parameters to the protected copy of the voice input to generate the revised voice model automatically without additional user input.

9. The method as recited in claim 1, further comprising displaying a notification, after the revised voice model is generated, that voice detection of the command has been improved.

10. A computing device comprising:
a processor; and
a computer-readable storage medium having stored thereon multiple instructions that, responsive to execution by the processor, cause the processor to perform acts comprising:
obtaining revised voice training parameters for a command;
applying the revised voice training parameters to a protected copy of a previously received voice input to generate a revised voice model for the command for a user of the computing device;
replacing a previously generated user-trained voice model with the revised voice model; and
for each of a set of multiple additional voice inputs received after the revised voice model is generated:
using the revised voice model to analyze the additional voice input to determine whether the additional voice input is the command;
performing the command in response to determining that the additional voice input is the command.

11. The computing device as recited in claim 10, the training parameters comprising phonemes and tuning parameters.

12. The computing device as recited in claim 10, the command comprising a launch phrase that activates the computing device to receive additional commands

13. The computing device as recited in claim 10, the protected copy of the previously received voice input comprising an encrypted copy of the previously received voice input.

14. The computing device as recited in claim 10, the protected copy of the previously received voice input having been previously encrypted and stored in the computer-readable storage media, and the acts further comprising decrypting the stored copy of the previously received and encrypted voice input.

15. A computing device comprising:
a microphone; and
a voice control system, implemented at least in part in hardware, the voice control system comprising:
a training module, implemented at least in part in hardware, configured to obtain revised voice training parameters for a command, apply the revised voice training parameters to a protected copy of a previously received voice input to generate a revised voice model for the command for a user of the computing device, and replace a previously generated user-trained voice model with the revised voice model; and
a command execution module, implemented at least in part in hardware, configured to, for each of a set of multiple additional voice inputs received after the revised voice model is generated, use the revised voice model to analyze the additional voice input to determine whether the additional voice input is the command, and perform the command in response to determining that the additional voice input is the command.

16. The computing device as recited in claim 15, the training parameters comprising phonemes and tuning parameters.

17. The computing device as recited in claim 15, the command comprising a launch phrase that activates the computing device to receive additional commands

18. The computing device as recited in claim 15, the protected copy of the previously received voice input comprising an encrypted copy of the previously received voice input.

19. The computing device as recited in claim 15, further comprising a storage device, the protected copy of the previously received voice input having been previously encrypted and stored in the storage device, and the training module further configured to decrypt the stored copy of the previously received and encrypted voice input.

20. The computing device as recited in claim 15, the training module further configured to apply the revised voice training parameters to the protected copy of the previously received voice input to generate the revised voice model automatically without additional user input.
